(19) United States
(12) Patent Application Publication
(10) Pub. No.: US 2024/0196102 A1
(43) Pub. Date: Jun. 13, 2024

(54) ELECTRONIC DEVICE FOR IMAGE PROCESSING USING AN IMAGE CONVERSION NETWORK, AND LEARNING METHOD OF IMAGE CONVERSION NETWORK

(71) Applicant: KOREA PHOTONICS TECHNOLOGY INSTITUTE, Gwangju (KR)

(72) Inventors: An Jin PARK, Gwangju (KR); Jeong Ho KIM, Gwangju (KR); Byung Sup RHO, Gwangju (KR)

(73) Assignee: KOREA PHOTONICS TECHNOLOGY INSTITUTE, Gwangju (KR)

(21) Appl. No.: 18/482,841

(22) Filed: Oct. 6, 2023

(30) Foreign Application Priority Data
Dec. 13, 2022 (KR) 10-2022-0174166

(51) Int. Cl. H04N 23/76; G06T 3/40; G06T 7/11; G06V 10/60

(52) U.S. Cl. CPC H04N 23/76; G06T 3/4053; G06T 7/11; G06V 10/60; G06T 2207/20081

(57) ABSTRACT

An electronic device for image processing using an image conversion network comprises: a communication unit communicating with a user terminal to receive a nighttime image having an illuminance lower than a threshold level from the user terminal and a daytime image captured by a camera of the user terminal; and a control unit for inputting the nighttime image into an image conversion network to generate a daytime image having an illuminance equal to or higher than the threshold level, wherein the image conversion network includes: a pre-processing unit for generating an input image by reducing the size of the nighttime image at a predetermined ratio; a day/night conversion network for generating a first daytime image by converting an illuminance on the basis of the input image; and a resolution conversion network for generating a final image by converting a resolution on the basis of the first daytime image.

### STATEMENT REGARDING GOVERNMENTAL SPONSORED RESEARCH

This invention was supported by Korea Planning & Evaluation Institute of Industrial Technology funded by the Ministry of Trade, Industry and Energy, Korea (RS-2022-00155891). [Research Project name: “Uncooled Ultra-High-Efficiency Image Sensor Arrays for Automative Night Vision”; Project Serial Number: 1415181749; Research Project Number: 00155891; Project performance organization: Solidvue, Inc.; Research Period: Apr. 1, 2022˜Dec. 31, 2023]

### BACKGROUND OF THE INVENTION

### Field of the Invention

The present invention relates to an electronic device for image processing using an image conversion network, and a learning method of the image conversion network.

### Background of the Related Art

As artificial intelligence techniques are developed, the field of computer vision for analyzing and understanding image data in images and/or videos are studied and developed in various ways recently. For example, in order to analyze traffic flow in an intelligent traffic system, computer vision techniques are applied to detect objects such as vehicles, pedestrians, and the like from image data and analyze movement of the objects. Artificial intelligence is mainly used in the computer vision techniques. In addition, in autonomous vehicles, computer vision techniques for detecting objects and analyzing movement of the objects are also applied for safe autonomous driving.

Vision systems using computer vision techniques are developing rapidly in recent years. However, most vision systems utilized in real life use a general camera, and the general camera may capture images having objects or surrounding environments that are difficult to recognize in a dark place or at night. Therefore, when an image captured by the general camera is input into the vision system, the objects or surrounding environments may not be properly recognized or analyzed from the captured image. Due to this reason, a problem arises in that the vision system should be used only in a specific time zone.

Although infrared cameras or thermal cameras are used in major facilities such as security and safety zones in order to collect image data of the surroundings in a dark place or at nighttime, as the images captured by these cameras are lack of expression quality compared to images captured by general cameras, there is a problem in that recognition and analysis performance is lowered.

Since computer vision techniques developed recently show good performance in daytime images captured by general cameras, when image data captured at night can be converted into daytime images, various computer vision techniques (vision systems) may be applied even in a nighttime environment.

Recently, various artificial intelligence-based image conversion techniques for converting nighttime images into daytime images are introduced. However, since artificial intelligence techniques applied to image conversion require a large amount of computation, it may take a lot of time to apply these techniques to high-resolution videos of 1080P or higher. Therefore, there is a problem in that it is difficult to apply the techniques to environments that require real-time processing, such as autonomous vehicles, security CCTVs, and the like.

### SUMMARY OF THE INVENTION

Therefore, the present invention has been made in view of the above problems, and it is an object of the present invention to provide an electronic device for image processing using an image conversion network, and a learning method of the image conversion network, which can convert images from nighttime images to daytime images, and enable real-time conversion by reducing conversion time.

To accomplish the above object, according to one aspect of the present invention, there is provided an electronic device for image processing using an image conversion network, the device comprising: a communication unit communicating with a user terminal to receive a nighttime image having an illuminance lower than a threshold level from the user terminal and a daytime image captured by a camera of the user terminal; and a control unit for inputting the nighttime image into an image conversion network to generate a daytime image having an illuminance equal to or higher than the threshold level, wherein the image conversion network includes: a pre-processing unit for generating an input image by reducing the size of the nighttime image at a predetermined ratio; a day/night conversion network for generating a first daytime image by converting an illuminance on the basis of the input image; and a resolution conversion network for generating a final image by converting a resolution on the basis of the first daytime image.

The day/night conversion network may include: a first generator for generating the first daytime image from the input image; a second generator for generating a first nighttime image from the first daytime image; and a discriminator for determining whether the first daytime image is the captured image or an image generated by the first generator.

Each of the first generator and the second generator may include: an encoder for generating an input value by increasing the number of channels and reducing a size from the input image, and including at least one convolution layer for performing down-sampling; a translation block including a plurality of residual blocks, in which each of the plurality of residual blocks applies a convolution operation, instance normalization, and a Rectified Linear Unit (ReLU) function operation to the input value; and a decoder including at least one transpose convolution layer for converting a result received from the translation block so that a size and number of channels are the same as those of the input image, and performing up-sampling.

The discriminator may include: at least one down-sampling block for dividing the input image into a plurality of patches; and a probability block for outputting a probability value of each of the plurality of patches for being the captured image.

A value of a first loss function indicating a result of determining whether the first daytime image is the captured image maybe derived.

A value of a second loss function indicating a difference between the first nighttime image and the input image maybe derived.

The resolution conversion network may include: a generator for generating a first high-resolution image having a resolution equal to or higher than a predetermined threshold level from the first daytime image; and a discriminator for determining whether the first high-resolution image is the captured image or an image generated by the generator.

A value of a third loss function indicating a result of determining whether the first high-resolution image is the captured image maybe derived.

The image conversion network further includes an additional generator for generating a second nighttime image on the basis of the first daytime image, and a value of a fourth loss function indicating a difference between the second nighttime image and the input image may be derived.

According to another aspect of the present invention, there is provided a learning method of an image conversion network, the method comprising the steps of: receiving an original image having an illuminance lower than a threshold level from a user terminal and an image captured through a camera, by a control unit; inputting the original image and the captured image into the image conversion network, by a control unit; generating an input image by reducing the size of the original image at a predetermined ratio, by the image conversion network; learning a method of generating a daytime image having an illuminance equal to or greater than the threshold level from a nighttime image having an illuminance lower than the threshold level on the basis of the input image and the captured image, and generating a first daytime image, by a first network included in the image conversion network; learning a method of generating a high-resolution image having a resolution equal to or greater than a threshold level from a low-resolution image having a resolution lower than the threshold level on the basis of the first daytime image and the captured image, and generating a first high-resolution image, by a second network included in the image conversion network; and learning on the basis of the first high-resolution image, by the first network and the second network.

The step of learning a method of generating a daytime image and generating a first daytime image may include the steps of: generating the first daytime image on the basis of the input image, by a first generator; determining whether the first daytime image is the captured image, by a discriminator; generating a first nighttime image on the basis of the first daytime image, by a second generator; and learning on the basis of a value of a first loss function indicating a result of the determination by the discriminator and a value of a second loss function indicating a difference between the first nighttime image and the input image, by the first generator and the second generator.

The step of learning a method of generating a high-resolution image and generating a first high-resolution image may include the steps of: generating the first high-resolution image on the basis of the first daytime image, by a generator; determining whether the first high-resolution image is the captured image, by a discriminator; and learning on the basis of a value of a third loss function indicating a result of determination by the discriminator, by the generator.

The step of learning on the basis of the first high-resolution image may include the steps of: generating a third nighttime image on the basis of the first high-resolution image, by an additional generator; and learning on the basis of a value of a fourth loss function indicating a difference between the third nighttime image and the input image, by a first generator among two generators included in the first network, a generator included in the second network, and the additional generator.

### BRIEF DESCRIPTION OF THE DRAWINGS

FIG. 1 is a block diagram showing an image processing system according to an embodiment of the present invention.

FIG. 2 is a block diagram showing the detailed configuration of the electronic device of FIG. 1.

FIG. 3 is a block diagram schematically showing an image conversion network according to an embodiment of the present invention.

FIG. 4 is a detailed block diagram showing the day/night conversion network of FIG. 3.

FIG. 5 is a detailed block diagram showing the two generators of FIG. 4.

FIG. 6 is a detailed block diagram showing the discriminator of FIG. 4.

FIG. 7 is a detailed block diagram showing the resolution conversion network 330 of FIG. 3.

FIG. 8 is a detailed block diagram showing the generator of FIG. 7.

FIG. 9 is a block diagram showing the overall network structure for training the day/night conversion network and the resolution conversion network of FIG. 3.

FIG. 10 is a flowchart illustrating a learning method of an image conversion network according to an embodiment.

### DETAILED DESCRIPTION OF THE PREFERRED EMBODIMENT

The present invention may be implemented in various ways to the extent that it does not deviate from the purposes, and may have one or more embodiments. In addition, the embodiments described in the “Best mode for carrying out the invention” and “Drawings” in the present invention are examples for specifically explaining the present invention, and do not restrict or limit the scope of the present invention.

Therefore, those that can be easily inferred from the “Best mode for carrying out the invention” and “Drawings” of the present invention by those skilled in the art may be construed as belonging to the scope of the present invention.

In addition, the size and shape of each component shown in the drawings may be exaggerated for the purpose of describing the embodiment, and do not limit the size and shape of the invention actually implemented.

Unless specifically defined, terms used in the specification of the present invention may have the same meaning as commonly understood by those skilled in the art.

Hereinafter, embodiments of the present invention will be described in detail with reference to the drawings.

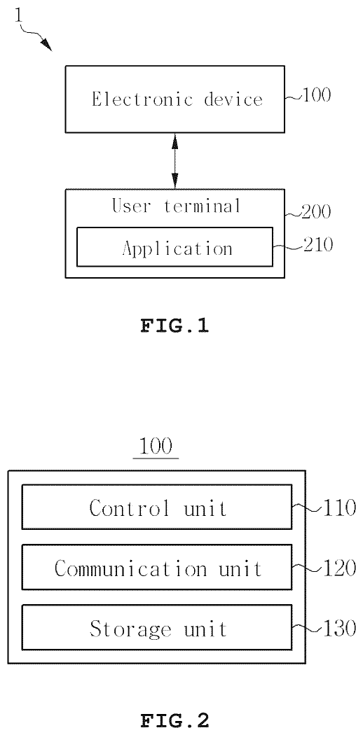

FIG. 1 is a block diagram showing an image processing system according to an embodiment of the present invention.

Referring to FIG. 1, an image processing system 1 may include an electronic device 100 and a user terminal 200.

The electronic device 100 and the user terminal 200 may exchange signals or data with each other through wired/wireless communication.

The electronic device 100 may receive an image from the user terminal 200. The electronic device 100 may process the image input from the user terminal 200 using the image conversion network according to an embodiment.

The electronic device 100 may include various devices capable of performing arithmetic processing and providing a result to the user. For example, the electronic device 100 may include both a computer and a server device, or may be in the form of any one of them.

Here, the computer may include, for example, a notebook computer, a desktop computer, a laptop computer, a tablet PC, a slate PC, and the like having a web browser mounted thereon.

Here, the server device is a server that processes information by communicating with an external device, and may include an application server, a computing server, a database server, a file server, a game server, a mail server, a proxy server, a web server, and the like.

An application 210 is installed in the user terminal 200. The application 210 may transmit an image that requires conversion to the electronic device 100 through the user terminal 200.

The user terminal 200 may be a wireless communication device or a computer terminal. Here, the wireless communication device is a device that guarantees portability and mobility, and may include all kinds of handheld-based wireless communication devices, such as Personal Communication System (PCS), Global System for Mobile communications (GSM), Personal Digital Cellular (PDC), Personal Handyphone System (PHS), Personal Digital Assistant (PDA), International Mobile Telecommunication 2000 (IMT-2000), Code Division Multiple Access 2000 (CDMA-2000), W-Code Division Multiple Access (W-CDMA), Wireless Broadband Internet (WiBro) terminal, smart phone, and the like, and wearable devices such as a watch, ring, bracelet, anklet, necklace, glasses, contact lenses, head-mounted device (HMD), and the like.

Hereinafter, an image of which the illuminance indicating brightness is lower than a predetermined threshold level is referred to as a nighttime image, and an image of which the illuminance is higher than or equal to the predetermined threshold level is referred to as a daytime image. That is, the nighttime image is a low-illuminance image, and the daytime image refers to a high-illuminance image.

In addition, as described below, an image of which the resolution indicating the quality of an image is lower than a predetermined threshold level is referred to as a low-resolution image, and an image of which the resolution is higher than or equal to the predetermined threshold level is referred to as a high-resolution image.

The electronic device 100 may convert a nighttime image into a daytime image.

FIG. 2 is a block diagram the detailed configuration of the electronic device of FIG. 1.

Referring to FIG. 2, the electronic device 100 may include a control unit 110, a communication unit 120, and a storage unit 130.

The control unit 110 may perform an operation of converting an image received through an image conversion network. The control unit 110 may control operation of the other components of the electronic device 100, such as the communication unit 120 and the storage unit 130.

The control unit 110 may be implemented as a memory for storing algorithms for controlling the operation of the components in the electronic device 100 or data of programs that implement the algorithms, and at least one function block for performing the operations described above using the data stored in the memory.

At this point, the control unit 110 and the memory may be implemented as separate chips. Alternatively, the control unit 110 and the memory may be implemented as a single chip.

The communication unit 120 may perform wired/wireless communication with the user terminal 200 to transmit and receive signals and/or data with each other. The communication unit 120 may receive nighttime images, as well as daytime images actually captured by a camera, from the user terminal 200.

The storage unit 130 may store an image conversion network according to an embodiment. The storage unit 330 may include volatile memory and/or non-volatile memory. The storage unit 130 may store instructions or data related to the components, one or more programs and/or software, an operating system, and the like in order to implement and/or provide operations, functions, and the like provided by the image processing system 1.

The programs stored in the storage unit 130 may include a program for converting an input image into a daytime image using an image conversion network according to an embodiment (hereinafter referred to as “image conversion program”). Such an image conversion program may include instructions or codes needed for image conversion.

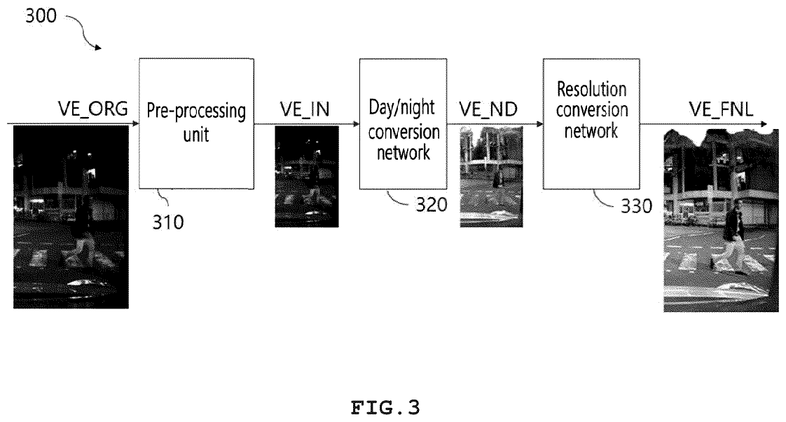

The control unit 110 may control any one or a plurality of the components described above in combination in order to implement various embodiments according to the present disclosure described below in FIGS. 3 to 9 on the electronic device 100.

The control unit 110 may output an image converted from an image received through the image conversion network according to an embodiment.

Hereinafter, the image conversion network according to an embodiment will be described.

FIG. 3 is a block diagram schematically showing an image conversion network according to an embodiment of the present invention.

Referring to FIG. 3, an image conversion network 300 according to an embodiment may include a pre-processor 310, a day/night conversion network 320, and a resolution conversion network 330. Each of the day/night conversion network 320 and the resolution conversion network 330 may include a plurality of networks. Each of the electronic device 100 of FIG. 2 and the image conversion network 300 may be implemented in a computer system including a recording medium that can be read by a computer.

The pre-processing unit 310 may receive an image from the user terminal 200. The pre-processing unit 310 may generate an input image VE_IN by reducing an original image VE_ORG at a predetermined ratio. The predetermined ratio may be a ratio of 1/2 or 1/4. For example, when the size of the original image VE_ORG is 1920*1080, the size of the input image VE_IN may be 960*540 reduced by 1/2 or 480*270 reduced by 1/4. The pre-processing unit 310 converts the image to a low resolution to reduce the operation amount of the image conversion network 300.

According to an embodiment, the image conversion network 300 converts a nighttime image captured in a nighttime zone or in a dark environment into a daytime image so that a result output from the image conversion network 300 may be applied to a vision system for recognizing or tracking objects without degradation of performance. Here, the object means a vehicle, a pedestrian, or the like, and the vision system for tracking may be a traffic flow analysis system.

Most vision systems apply a computer vision technique after reducing the size of an original image by a certain ratio for real-time processing. This is since that most computer vision systems may perform real-time processing only when the image size is smaller than a predetermined size. For example, YOLOv5 for recognizing objects such as vehicles, pedestrians, and the like may perform real-time processing only when the image size is 600*600 or smaller.

Therefore, since performance of the computer vision technique, which is the actual purpose, is not greatly affected although the size of the original image is reduced at a predetermined ratio with respect to the original image, the pre-processing unit 310 changes the size of the original image at a predetermined ratio in an embodiment.

Although the pre-processing unit 310 is shown as being included in the image conversion network 300 in FIG. 3, the present invention is not limited thereto. The image conversion network 300 may input an image with a reduced size through a user terminal or an input module, without including the pre-processing unit 310. It is assumed hereinafter that the image conversion network 300 includes a pre-processing unit 310 for convenience of explanation.

The day/night conversion network 320 may receive an image VE_IN, perform illuminance conversion from a nighttime image to a daytime image, and generate a day/night conversion image VE_ND.

The resolution conversion network 330 may receive the day/night conversion image VE_ND, perform resolution conversion from a low-resolution image to a high-resolution image, and generate a result image VE_FNL.

According to an embodiment, since the image conversion network 300 converts the original image VE_ORG by reducing the size, it may perform conversion from the original image VE_ORG into the result image VE_FNL in real time as a fast operation is possible compared to a method of converting the original image VE_ORG without reducing the size.

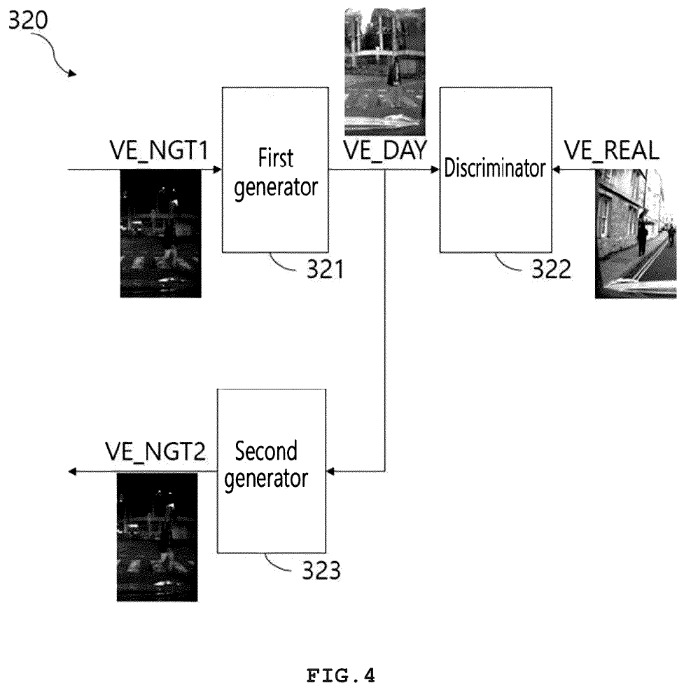

Hereinafter, the operation of the day/night conversion network 320 will be described in detail with reference to FIG. 4.

FIG. 4 is a detailed block diagram showing the day/night conversion network of FIG. 3.

Referring to FIG. 4, the day/night conversion network 320 may include two generators 321 and 323 and one discriminator 322.

A first generator 321 may be a network that generates a daytime image VE_DAY from a nighttime image VE_NGT1. Here, the first generator 321 may be used to convert the nighttime image into the daytime image.

A second generator 323 may be a network that generates a nighttime image VE_NGT2 from a daytime image VE_DAY. Here, the second generator 323 may be used to convert the daytime image into the nighttime image.

The discriminator 322 may be a network that determines whether an input image is a real daytime image VE_REAL actually captured by a camera or a daytime image VE_DAY generated by the first generator 321. The discriminator 322 may be used to determine the similarity between the daytime image VE_DAY generated by the first generator 321 and the real daytime image VE_REAL.

The discriminator 322 and the second generator 323 may train the first generator 321 to generate a daytime image VE_DAY indistinguishably similar to the real daytime image VE_REAL. Hereinafter, the meaning that two images are indistinguishably similar may indicate that the degree of similarity between the two images exceeds a predetermined threshold level.

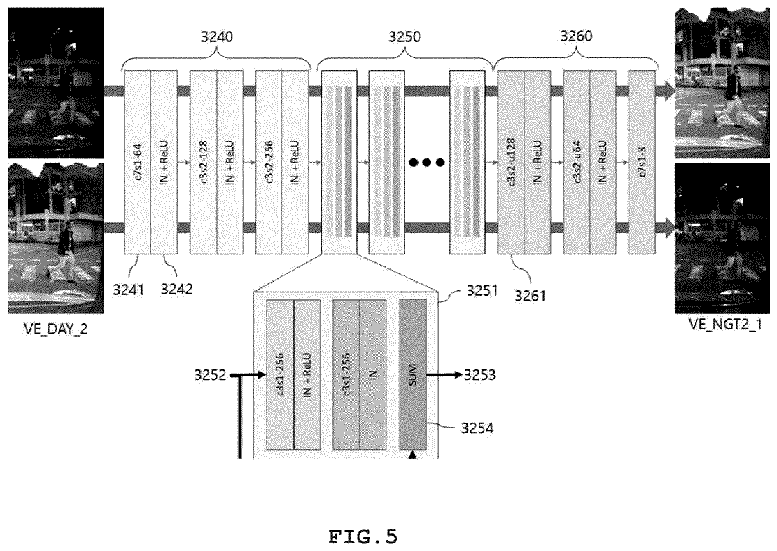

The two generators 321 and 323 may have the same network structure. Hereinafter, the structure of each of the two generators 321 and 323 will be described with reference to FIG. 5.

The nighttime image VE_NGT1 in FIG. 4 may be an example of the input image VE_IN in FIG. 3. The daytime image VE_DAY in FIG. 4 may be an example of the day/night conversion image VE_ND in FIG. 3. The real daytime image VE_REAL in FIG. 4 may be an image input from the user terminal 200.

FIG. 5 is a detailed block diagram showing the two generators of FIG. 4.

Referring to FIG. 5, each of the two generators 321 and 323 may include an encoder 3240, a translation block 3250, and a decoder 3260.

The first generator 321 may generate a daytime image VE_DAY_1 using a nighttime image VE_NGT1_1 as an input. The second generator 323 may generate a nighttime image VE_NGT2_1 using a daytime image VE_DAY_2 as an input.

The encoder 3240 may transmit an input value generated by increasing the number of channels and reducing the size of each of the input images VE_NGT1_1 and VE_DAY_2 to the translation block 3250. The encoder 3240 may include at least one convolution layer (s) that performs down-sampling for reducing the size of an image according to a stride value.

The translation block 3250 may include N residual blocks (N is a natural number greater than or equal to 1). The translation block 3250 may sequentially pass the N residual blocks and transmit a calculated result to the decoder 3260. Each of the N residual blocks may apply a convolution operation, an instance normalization operation, and a Rectified Linear Unit (ReLU) function operation to an input value received from the encoder 3240.

The decoder 3260 may output final results VE_DAY_1 and VE_NGT2_1 after converting the result calculated by the translation block 3250 to have the same size and number of channels as those of the input images VE_NGT1_1 and VE_DAY_2. The decoder 3260 may include at least one transpose convolution layer (s) that performs up-sampling for increasing the size of an image according to a stride value.

What is expressed in the form of “cYsX-k” in FIG. 5 may indicate a Y*Y convolution layer in which the stride value is X and the number of filters is k. For example, a first layer 3241 of the encoder 3240 is expressed as “c7s1-64”, which indicates a 7*7 convolution layer in which the stride value is 1 and the number of filters is 64.

The convolution layer may perform a down-sampling function of reducing the size according to the stride value.

In addition, what is expressed in the form of “cYsX-uk” in FIG. 5 may indicate a Y*Y transpose convolution layer in which the stride value is X and the number of filters is k. For example, a first layer 3261 of the decoder 3260 is expressed as “c3s2-u128”, which indicates a 3*3 transpose convolution layer in which the stride value is 2 and the number of filters is 128.

Contrary to the convolution layer, the transpose convolution layer may perform an up-sampling function of increasing the size according to the stride value.

In FIG. 5, the second layer 3242 of the encoder 3240 is expressed as “IN+ReLU”, which may indicate Instance Normalization and ReLU layers. The second layer 3242 of the encoder 3240 may output a result after sequentially applying Instance Normalization and ReLU.

Each of the N residual blocks may add (SUM) a result value, obtained by sequentially applying the five layers, and the input value of the block in units of pixels, and transmit a result of the sum to the next block. Here, the five layers may include convolution c3s1-256, instance normalization, ReLU (IN_ReLU), convolution c3s1-256, and instance normalization (IN).

For example, the residual block 3251 may add (3254) a result value, obtained by sequentially applying five layers of convolution c3s1-256, instance normalization, ReLU (IN_ReLU), convolution c3s1-256, and instance normalization (IN) from the input value 3252, and the input value 3252 of the block in units of pixels, and transmit a result of the sum to the next block 3253.

The nighttime image VE_NGT1_1 in FIG. 5 may be an example of the nighttime image VE_NGT1 in FIG. 4. The daytime image VE_DAY_1 in FIG. 5 may be an example of the daytime image VE_DAY in FIG. 4. In FIG. 5, the daytime image VE_DAY_2 may be the daytime image VE_DAY_1.

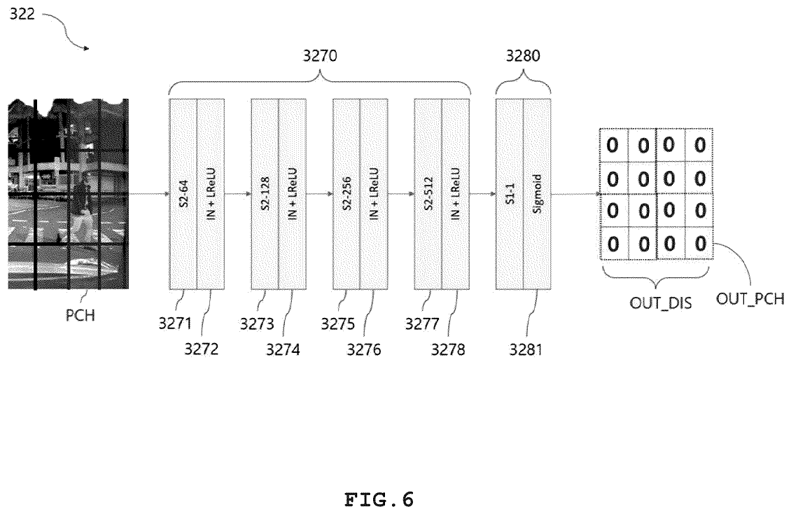

Hereinafter, the structure of the discriminator 322 will be described with reference to FIG. 6.

FIG. 6 is a detailed block diagram showing the discriminator of FIG. 4.

Referring to FIG. 6, the discriminator 322 may include M down-sampling blocks 3270 and a probability block 3280 (where M is a natural number greater than or equal to 1).

The M down-sampling blocks 3270 (where M is a natural number greater than or equal to 1) may divide an input image into a plurality of patches.

The probability block 3280 may output a probability value of each of the plurality of patches for being a captured image.

The “S2-64” layer 3271 and the “IN+LReLU” layer 3272 are a first block, the “S2-128” layer 3273 and the “IN+LReLU” layer 3274 are a second block, the “S2-256” layer 3275 and the “IN+LReLU” layer 3276 are a third block, and the “S2-512” layer 3277 and the “IN+LReLU” layer 3278 are a fourth block. Although it is illustrated in FIG. 6 that the discriminator 322 includes four down-sampling blocks, the present invention is not limited thereto, and the discriminator 322 may include at least one down-sampling block.

The discriminator 322 may be implemented using PatchGAN. The PatchGAN is a network that can determine whether an image is an image generated by a generator or an actually captured image for each patch PCH divided into O*P pieces (O and P are a natural number greater than or equal to 1) rather than the entire area of the image.

What is expressed in the form of “SX-k” in FIG. 6 indicates an O*P convolution layer in which the stride value is X and the number of filters is k.

Referring to FIG. 6, an input image may be divided into 4*4 patches PCH. In the example of FIG. 6, a first layer 3271 is expressed as “S2-64”, which indicates a 4*4 convolution layer in which the stride value is 2 and the number of filters is 64.

Each of the M down-sampling blocks 3270 uses a convolution layer having a stride value of 2 to reduce the size of the input image. In addition, the number M of the down-sampling blocks 3270 may be adjusted to reduce the size of the input image to the number of patches O*P defined by the user. For example, when the size of the input image is 512*512 and the size of the patch defined by the user is 32*32, the discriminator 322 may include four down-sampling blocks (a block down-sampling from 512 to 256, a block down-sampling from 256 to 128, a block down-sampling from 128 to 64, and a block down-sampling from 64 to 32).

In the M down-sampling blocks 3270, the IN+LReLU layers 3272, 3274, 3276, and 3278 may represent Instance Normalization and Leaky ReLU layers. Each of the IN+LReLU layers 3272, 3274, 3276, and 3278 may sequentially apply Instance Normalization and Leaky ReLU and then output a result.

The probability block 3280 may output a probability value indicating whether each patch PCH is an image actually captured or an image converted by a generator. For example, the probability value may indicate a probability of each patch PCH for being an actually captured image VE_REAL. Each patch PCH may generate an output OUT_DIS indicating a probability value between 0 and 1. The probability block 3280 may include a sigmoid layer 3281 as a last layer to generate a probability value corresponding to each patch OUT_PCH of the output OUT_DIS.

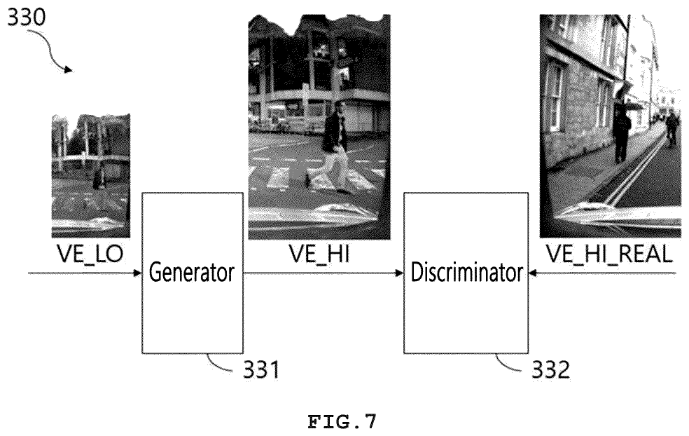

FIG. 7 is a detailed block diagram showing the resolution conversion network 330 of FIG. 3.

Referring to FIG. 7, the resolution conversion network 330 may include a generator 331 and a discriminator 332.

The generator 331 may be a network that generates a high-resolution image VE_HI from a low-resolution image VE_LO. The generator 331 may be used for the purpose of converting a low-resolution image into a high-resolution image.

The discriminator 332 may be a network that determines whether an input image is a real high-resolution image VE_HI_REAL actually captured by a camera or a high-resolution image VE_HI generated by the generator 331. The discriminator 332 may train the generator 331 to generate a high-resolution image VE_HI indistinguishably similar to the real high-resolution image VE_HI_REAL.

The resolution conversion network 330 may convert a low-resolution image into a high-resolution image. A technique of converting a low-resolution image into a high-resolution image is referred to as super-resolution.

In one embodiment, a super-resolution network known as the resolution conversion network 330 may be used. For example, the resolution conversion network 330 may be an SRGAN network.

The description of the discriminator 332 of FIG. 7 may be the same as that of the discriminator 322 shown in FIG. 6. For example, the discriminator 332 of FIG. 7 may also include M down-sampling blocks 3270 and a probability block 3280 (M is a natural number greater than or equal to 1).

The low-resolution image VE_LO in FIG. 7 may be an example of the day/night conversion image VE_ND in FIG. 3. In FIG. 7, the high-resolution image VE_HI may be an example of the result image VE_FNL. In FIG. 7, the real high-resolution image VE_HI_REAL may be an image input from the user terminal 200.

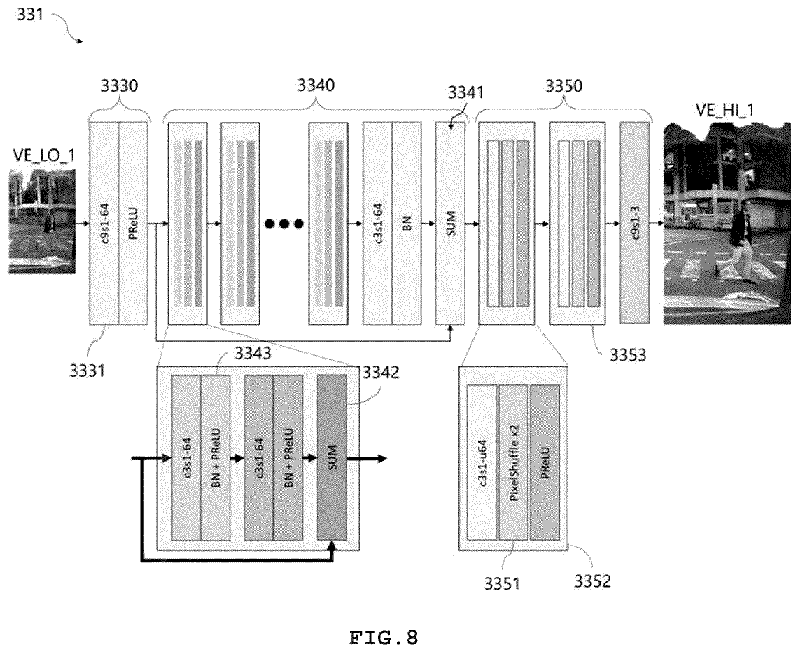

Hereinafter, the detailed structure of the generator 331 will be described with reference to FIG. 8.

FIG. 8 is a detailed block diagram showing the generator of FIG. 7.

Referring to FIG. 8, the generator 331 may include a low-resolution block 3330, a translation block 3340, and a high-resolution block 3350.

The low-resolution block 3330 may increase the number of channels of the input low-resolution image VE_LO_1 and transmit it to the translation block 3340.

The translation block 3340 may include Q residual blocks (Q is a natural number greater than or equal to 1). The translation block 3340 may sequentially pass the Q residual blocks and transmit a calculated result to the high-resolution block 3350.

The high-resolution block 3350 may convert the result calculated by the translation block 3340 to a size the same as that of the original image VE_ORG, and output the final result VE_HI_1 with an adjusted number of channels. The high-resolution block 3350 may adjust the number of channels to 3 when the final result image is an RGB image and to 1 when the final result image is a gray image.

What is expressed in the form of “cYsX-k” in FIG. 8 may indicate a Y*Y convolution layer in which the stride value is X and the number of filters is k. For example, a first layer 3331 of the low-resolution block 3330 is expressed as “c9s1-64”, which indicates a 9*9 convolution layer in which the stride value is 1 and the number of filters is 64.

In the translation block 3340, the SUM layers 3341 and 3342 may indicate layers that perform a pixel unit sum of input data. Each of the SUM layers 3341 and 3342 may add two pieces of input information (e.g., feature map) input into the SUM layers 3341 and 3342 in units of pixels, and then transmit a result to a next layer.

In the high-resolution block 3350, the PixelShuffle layer 3351 may perform up-sampling to double the size. As shown in FIG. 8, in order to up-sample the size by 4 times, a network may be configured by consecutively arranging the block 3352 including the PixelShuffle layer 3351 twice 3352 and 3353 in the high-resolution block 3350. Although it is shown FIG. 8 that the high-resolution block 3350 is includes two blocks including the PixelShuffle layer, the present invention is not limited thereto. The high-resolution block 3350 may include one or more blocks including PixelShuffle layer according to a multiple of a size to be up-sampled.

In FIG. 8, the BN+PRELU layer 3343 may indicate batch normalization and parametric ReLU. The BN+PRELU layer 3343 may sequentially apply batch normalization and parametric ReLU and transmit a result to a next layer.

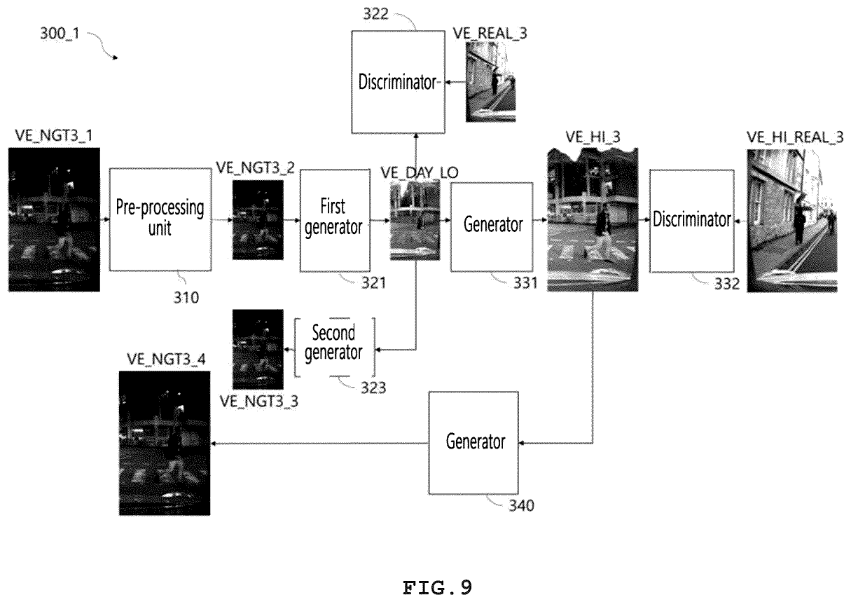

Referring to FIG. 3, since the image conversion network 300 includes a day/night conversion network 320 and a resolution conversion network 330, a method capable of simultaneously training the two networks 320 and 330 is required. Hereinafter, the network will be described with reference to FIG. 9 before training the two networks 320 and 330 of FIG. 3.

The low-resolution image VE_LO_1 in FIG. 8 may be an example of the low-resolution image VE_LO in FIG. 7. The final result VE_HI_1 in FIG. 8 may be an example of the high-resolution image VE_HI in FIG. 7.

FIG. 9 is a block diagram showing the overall network structure for training the day/night conversion network and the resolution conversion network of FIG. 3.

Referring to FIG. 9, the image conversion network 300_1 to be learned includes a pre-processor 310, includes a first generator 321, a discriminator 322, and a second generator 323 of the day/night conversion network, and may include a generator 331 and a discriminator 332 of the resolution conversion network. In addition, the image conversion network 300_1 may further include one additional generator 340 to simultaneously train the first generator 321, the second generator 323, and the generator 331.

The additional generator 340 may generate the high-resolution nighttime image VE_NGT3_4 from the high-resolution daytime image VE_HI_3. The additional generator 340 may have the same structure as each of the two generators 321 and 323 shown in FIG. 5. For example, the additional generator 340 may have the same structure as the second generator 323.

In an embodiment, four loss functions may be provided to simultaneously train the image conversion network 300_1.

A first loss function is a loss function related to conversion from a daytime image to a nighttime image. In other words, the first loss function may be a loss function for the day/night conversion network 320. The first loss function may be expressed as shown in [Equation 1].

$${ℒ}_{G A N}^{N D} = \frac{1}{N} {\sum }_{i = 1}^{N} {‖ {D}_{N D} ( {G}_{N D}^{L} ( {X}_{i} ) ) - 1 ‖}_{2} \qquad [ Equation 1 ]$$

Here, END [symbol] _{GAN}^{ND} may denote the first loss function, N may denote the number of learning data, and Xᵢ may denote the i-th learning image. G_{ND}^{L} may denote the first generator 321, and D_{ND} may denote the discriminator 322.

The first loss function in [Equation 1] may be used to train the first generator 321 so that the discriminator 322 may determine the low-resolution daytime image VE_DAY_LO indicating a result converted by the first generator 321.

The discriminator 322 may determine whether the low-resolution daytime image VE_DAY_LO is an actually captured real daytime image VE_REAL_3. When it is determined that the image is an actually captured real daytime image VE_REAL_3, the discriminator 322 may output ‘1’. According to the determination result of the discriminator 322, a value of the first loss function in [Equation 1] may be derived.

The first loss function in [Equation 1] may be a loss function used to learn the first generator 321 so that the discriminator 322 may generate a low-resolution daytime image VE_DAY_LO indistinguishably similar to the real daytime image VE_REAL_3.

The value of the first loss function in [Equation 1] may indicate a result of the determination by the discriminator 322 whether the low-resolution daytime image VE_DAY_LO is the real daytime image VE_REAL_3. As the value of the first loss function increases, the difference between the low-resolution daytime image VE_DAY_LO and the real daytime image VE_REAL_3 may increase. The first generator 321 and/or the second generator 323 may learn a method of generating a daytime image from a nighttime image in a direction decreasing the value of the first loss function in [Equation 1]. For example, the first generator 321 and/or the second generator 323 may repeat the learning process until the value of the first loss function in [Equation 1] decreases to be smaller than or equal to a predetermined reference value.

A second loss function is a loss function related to conversion from a daytime image to a nighttime image. In other words, the second loss function may be a loss function for the day/night conversion network 320. The second loss function may be expressed as shown in [Equation 2].

$${ℒ}_{C Y C}^{N D} = \frac{1}{N} {\sum }_{i = 1}^{N} {‖ {G}_{D N}^{L} ( {G}_{N D}^{L} ( {X}_{i} ) ) - {X}_{i} ‖}_{2} \qquad [ Equation 2 ]$$

Here, END [symbol] _{CYC}^{ND} may denote the second loss function, N may denote the number of learning data, and Xᵢ may denote the i-th learning image. G_{ND}^{L} may denote the first generator 321, and G_{DN}^{L} may denote the second generator 323.

The pre-processing unit 310 may generate an input image VE_NGT3_2 by reducing an original image VE_NGT3_1 at a predetermined ratio. The first generator 321 may generate the low-resolution daytime image VE_DAY_LO on the basis of the input image VE_NGT3_2. In addition, the second generator 323 may generate a nighttime image VE_NGT3_3 on the basis of the low-resolution daytime image VE_DAY_LO.

A value of the second loss function in [Equation 2] may be derived on the basis of the input image VE_NGT3_2 and the nighttime image VE_NGT3_3.

The second loss function in [Equation 2] may be used to learn the first generator 321 and the second generator 323 so that the low-resolution daytime image VE_DAY_LO converted by the first generator 321 is indistinguishably similar to the nighttime image VE_NGT3_3 converted by the second generator 323.

The value of the second loss function in [Equation 2] may indicate a difference between the nighttime image VE_NGT3_3 and the input image VE_NGT3_2. As the value of the second loss function increases, the difference between the nighttime image VE_NGT3_3 and the input image VE_NGT3_2 may increase. The first generator 321 and/or the second generator 323 may learn a method of generating a daytime image from a nighttime image in a direction decreasing the value of the second loss function in [Equation 2]. For example, the first generator 321 and/or the second generator 323 may repeat the learning process until the value of the second loss function in [Equation 2] decreases to be smaller than or equal to a predetermined reference value.

A third loss function is a loss function related to conversion from a low-resolution image to a high-resolution image. In other words, the third loss function may be a loss function for the resolution conversion network 330. The third loss function may be expressed as shown in [Equation 3].

$${ℒ}_{G A N}^{L H} = \frac{1}{N} {\sum }_{i = 1}^{N} {‖ {D}_{L H} ( {G}_{L H} ( {G}_{N D}^{L} ( {X}_{i} ) ) ) - 1 ‖}_{2} \qquad [ Equation 3 ]$$

Here, [symbol] _{GAN}^{LH} may denote the third loss function, N may denote the number of learning data, and Xᵢ may denote the i-th learning image. G_{ND}^{L} may denote the first generator 321, G_{LH} may denote the generator 331, and D_{LH} may denote the discriminator 322.

The generator 331 may generate the high-resolution daytime image VE_HI_3 on the basis of the low-resolution daytime image VE_DAY_LO generated by the first generator 321.

The discriminator 322 may determine whether the high-resolution daytime image VE_HI_3 is an actually captured real high-resolution image VE_HI_REAL_3. When it is determined that the high-resolution daytime image VE_HI_3 is an actually captured real high-resolution image VE_HI_REAL_3, the discriminator 322 may output ‘1’. According to the determination result of the discriminator 322, a value of the third loss function in [Equation 1] may be derived.

The third loss function in [Equation 3] is a loss function for learning the generator 331 so that the discriminator 332 may determine the high-resolution daytime image VE_HI_3 generated by the generator 331 as 1. The third loss function in [Equation 3] may be used to learn the generator 331 so that the discriminator 322 may generate a high-resolution daytime image VE_HI_3 indistinguishably similar to the real high-resolution image VE_HI_REAL_3.

The value of the third loss function in [Equation 3] may indicate a result of the determination by the discriminator 332 whether the high-resolution daytime image VE_HI_3 is an actually captured real high-resolution image VE_HI_REAL_3. As the value of the third loss function increases, the difference between the high-resolution daytime image VE_HI_3 and the real high-resolution image VE_HI_REAL_3 may increase. The generator 331 may learn a method of generating a high-resolution image from a low-resolution image in a direction decreasing the value of the third loss function in [Equation 3]. For example, the generator 331 may repeat the learning process until the value of the third loss function in [Equation 3] decreases to be smaller than or equal to a predetermined reference value.

A fourth loss function is a loss function related to the day/night conversion network 320 and the resolution conversion network 330. The fourth loss function may be expressed as shown in [Equation 4].

$${ℒ}_{C Y C}^{N D} = \frac{1}{N} {\sum }_{i = 1}^{N} {‖ {G}_{D N}^{H} ( {G}_{L H} ( {G}_{N D}^{L} ( {x}_{i} ) ) ) - {X}_{i} ‖}_{2} \qquad [ Equation 4 ]$$

Here, [symbol] _{CYC}^{ND} may denote the fourth loss function, N may denote the number of learning data, and Xᵢ may denote the i-th learning image. G_{ND}^{L} may denote the first generator 321, G_{LH} may denote the generator 331, and G_{DN}^{H} may denote the additional generator 340.

The additional generator 340 may generate the high-resolution nighttime image VE_NGT3_4 on the basis of the high-resolution daytime image VE_HI_3.

A value of the fourth loss function in [Equation 4] may be derived on the basis of the high-resolution nighttime image VE_NGT3_4.

The fourth loss function in [Equation 4] may be a loss function that calculates a difference between the high-resolution nighttime image VE_NGT3_4 and the original image VE_NGT3_1 or a difference between the high-resolution nighttime image VE_NGT3_4 and the input image VE_NGT3_2. The fourth loss function in [Equation 4] may be used to learn the generator and the discriminator to generate the high-resolution nighttime image VE_NGT3_4 indistinguishably similar to the input image VE_NGT3_2 (or the original image VE_NGT3_1).

The first generator 321 and the generator 331 may operate in the process of converting the original image VE_NGT3_1 into the high-resolution daytime image VE_HI_3. The additional generator 340 may operate in the process of converting the high-resolution daytime image VE_HI_3 into the high-resolution nighttime image VE_NGT3_4. Here, the first generator 321, the generator 331, and the additional generator 340 are all associated with the fourth loss function in [Equation 4]. Therefore, the three generators 321, 331, and 340 may be fine-tuned at the same time on the basis of the fourth loss function in [Equation 4].

The value of the fourth loss function in [Equation 4] may indicate a difference between the high-resolution nighttime image VE_NGT3_4 and the input image VE_NGT3_2 (or the original image VE_NGT3_1). As the value of the fourth loss function increases, the difference between the high-resolution nighttime image VE_NGT3_4 and the input image VE_NGT3_2 (or the original image VE_NGT3_1) may increase. The first generator 321, the generator 331, and the additional generator 340 may learn a method of generating the high-resolution daytime image VE_HI_3 in a direction decreasing the value of the fourth loss function in [Equation 4]. For example, the first generator 321, the generator 331, and the additional generator 340 may repeat the learning process until the value of the fourth loss function in [Equation 4] decreases to be smaller than or equal to a predetermined reference value.

The original image VE_NGT3_1 in FIG. 9 may be an example of the original image VE_ORG in FIG. 3. The input image VE_NGT3_2 in FIG. 9 may be an example of the input image VE_IN in FIG. 3. The low-resolution daytime image VE_DAY_LO in FIG. 9 may be an example of the day/night conversion image VE_ND in FIG. 3. The high-resolution daytime image VE_HI_3 in FIG. 9 may be an example of the result image VE_FNL in FIG. 3. In FIG. 9, the real daytime image VE_REAL_3 and/or the real high-resolution image VE_HI_REAL_3 may be images input from the user terminal 200.

The first loss function in [Equation 1] and the second loss function in [Equation 2] may be used to learn the day/night conversion network 320, the third loss function in [Equation 3] may be used to learn the resolution conversion network 330, and the fourth loss function in [Equation 4] may be used to simultaneously learn the day/night conversion network 320 and the resolution conversion network 330.

The electronic device 100 according to an embodiment may learn the image conversion network 300 by learning all of the plurality of loss functions (Equations 1 to 4). The electronic device 100 may derive the result image VE_FNL shown in FIG. 3 by inputting the original image VE_ORG shown in FIG. 3 into the learned image conversion network 300.

According to an embodiment, there is provided an artificial intelligence-based image processing system 1 that converts a nighttime image into a daytime image at a high resolution in real time. The image processing system 1 may convert an input image using the image conversion network 300.

Through the proposed method, the image processing system 1 may allow various vision systems of object recognition, tracking, and the like to be applied without restriction of time and place even in a nighttime zone or in a dark environment.

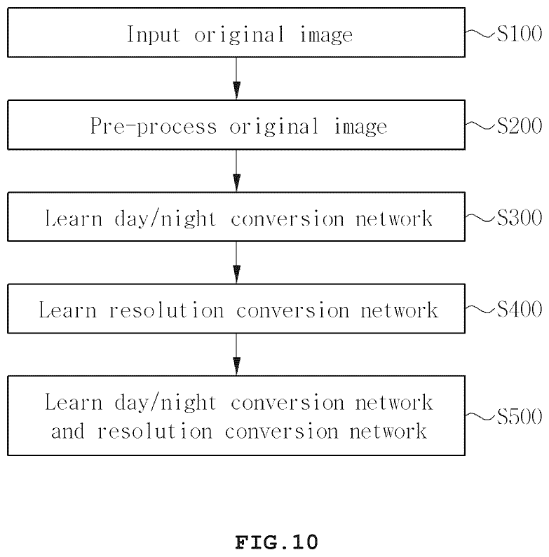

FIG. 10 is a flowchart illustrating a learning method of an image conversion network according to an embodiment.

Descriptions duplicated with the descriptions of the electronic device 100 and the image conversion networks 300 and 300_1 may be omitted. Hereinafter, a learning method of the image conversion network 300 based on the image conversion network 300_1 of FIG. 9 will be described.

Referring to FIG. 10, the electronic device 100 may train the image conversion network 300 a method of generating a result image VE_FNL on the basis of an input image VE_IN.

The communication unit 120 may receive an original image VE_ORG from the user terminal 200 and transmit it to the control unit 110 (S100).

The control unit 110 may input the original image VE_NGT3_1 into the image conversion network 300. The communication unit 120 may receive the real daytime image VE_REAL_3 and/or the real high-resolution image VE_HI_REAL_3 of FIG. 9 from the user terminal 200 and transmit the images to the control unit 110. The control unit 110 may input the real daytime image VE_REAL_3 and/or the real high-resolution image VE_HI_REAL_3 into the video conversion network 300.

The pre-processing unit 310 may pre-process the original image VE_ORG (S200).

The pre-processing unit 310 may generate an input image VE_NGT3_2 by reducing the original image VE_NGT3_1 at a predetermined ratio.

The day/night conversion network 320 may learn a method of generating a daytime image from a nighttime image on the basis of the input image VE_NGT3_2 and the real daytime image VE_REAL_3 (S300).

The first generator 321 may generate a low-resolution daytime image VE_DAY_LO on the basis of the input image VE_NGT3_2.

The discriminator 322 may determine whether the low-resolution daytime image VE_DAY_LO is the real daytime image VE_REAL_3. According to the determination result of the discriminator 322, a value of a first loss function may be derived.

The second generator 323 may generate a nighttime image VE_NGT3_3 on the basis of the low-resolution daytime image VE_DAY_LO. A value of the second loss function indicating a difference between the nighttime image VE_NGT3_3 and the input image VE_NGT3_2 may be derived on the basis of the nighttime image VE_NGT3_3 and the input image VE_NGT3_2.

The first generator 321 and the second generator may learn on the basis of the derived values of the first loss function and the second loss function.

The day/night conversion network 320 may learn a method of generating the low-resolution daytime image VE_DAY_LO on the basis of the input image VE_NGT3_2 and the real daytime image VE_REAL_3 by learning the first loss function in [Equation 1] and the second loss function in [Equation 2]. For example, the day/night conversion network 320 may repeat the learning process until the value of the first loss function in [Equation 1] and the value of the second loss function in [Equation 2] decrease to be smaller than a predetermined reference value.

The resolution conversion network 330 may learn a method of generating a high-resolution image from a low-resolution image on the basis of the low-resolution daytime image VE_DAY_LO and the real high-resolution image VE_HI_REAL_3 (S400).

The generator 331 may generate a high-resolution daytime image VE_HI_3 on the basis of the low-resolution daytime image VE_DAY_LO.

The discriminator 332 may determine whether the high-resolution daytime image VE_HI_3 is the real high-resolution image VE_HI_REAL_3. According to the determination result of the discriminator 332, a third loss function value may be derived. According to the determination result of the discriminator 322, a value of the third loss function may be derived.

The generator 331 may learn on the basis of the derived value of the third loss function.

The resolution conversion network 330 may learn a method of generating the high-resolution daytime image VE_HI_3 on the basis of the low-resolution daytime image VE_DAY_LO and the real high-resolution image VE_HI_REAL_3 by learning the third loss function in [Equation 3]. For example, the resolution conversion network 330 may repeat the learning process until the value of the third loss function in [Equation 3] decreases to be smaller than a predetermined reference value.

The day/night conversion network 320 and the resolution conversion network 330 may learn on the basis of the high-resolution daytime image VE_HI_3.

The additional generator 340 may generate a high-resolution nighttime image VE_NGT3_4 on the basis of the high-resolution daytime image VE_HI_3.

A value of the fourth loss function indicating a difference between the high-resolution nighttime image VE_NGT3_4 and the input image VE_NGT3_2 (or the original image VE_NGT3_1) may be derived.

The first generator 321, the generator 331, and the additional generator 340 may learn on the basis of the derived value of the fourth loss function.

The day/night conversion network 320 and the resolution conversion network 330 may learn a method of generating the high-resolution daytime image VE_HI_3 on the basis of the input image VE_NGT3_2 by learning the fourth loss function in [Equation 4]. For example, the day/night conversion network 320 and the resolution conversion network 330 may repeat the learning process until the value of the fourth loss function in [Equation 4] decreases to be smaller than a predetermined reference value.

The electronic device 100 may derive a result image VE_FNL by inputting the original image VE_ORG into the learned image conversion network 300.

The electronic device 100 may include a processor. The processor may execute programs and control the image processing system 1. Program codes executed by the processor may be stored in the memory.

The embodiments described above may be implemented as hardware components, software components, and/or a combination of hardware components and software components. For example, the devices, methods, and components described in the embodiments may be implemented using one or more general-purpose computers or special-purpose computers, such as a processor, controller, arithmetic logic unit (ALU), digital signal processor, microcomputer, field programmable gate array (FPGA), programmable logic unit (PLU), microprocessor, any other device that can execute instructions and respond, and the like. A processing device may run an operating system (OS) and one or more software applications executed on the operating system. In addition, the processing device may also access, store, manipulate, process, and generate data in response to execution of the software. Although it is described that one processing device is used in some cases for convenience of understanding, those skilled in the art will understand that the processing device may include a plurality of processing elements and/or a plurality of types of processing elements. For example, the processing device may include a plurality of processors or one processor and a controller. In addition, other processing configurations, such as parallel processors, are possible.

The method according to an embodiment may be implemented in the form of program instructions that can be executed through various computer means and recorded on a computer-readable medium. The computer-readable medium may include program instructions, data files, data structures, and the like alone or in combination. The program instructions recorded on the medium may be specially designed and configured for the embodiment or may be known to and used by those skilled in computer software. Examples of the computer-readable recording medium include magnetic media such as hard disks, floppy disks, and magnetic tapes, optical media such as CD-ROMs and DVDs, magneto-optical media such as floptical disks, and hardware devices specially configured to store and execute program instructions such as ROM, RAM, flash memory, and the like. Examples of the program instructions include high-level language codes that can be executed by a computer using an interpreter, as well as machine language codes such as those produced by a compiler. The hardware devices described above may be configured to operate as one or more software modules to perform the operations of the embodiments, and vice versa. The software may include computer programs, codes, instructions, or combinations of one or more of these, and may configure the processing device to operate as desired or may independently or collectively direct the processing device. The software and/or data may be permanently or temporarily embodied in a certain type of machine, component, physical device, virtual equipment, computer storage medium or device, or a transmitted signal wave so as to be interpreted by the processing device or provide instructions or data to the processing device. The software may be distributed on computer systems connected through a network to be stored or executed in a distributed manner. The software and data may be stored on one or more computer-readable recording media.

The present invention may convert nighttime images into daytime images while satisfying both real-time conversion and high-resolution conversion.

According to the present invention, the operation amount of the image conversion network that converts nighttime images into daytime images can be reduced by changing illuminance of the images after converting the images into images of a low resolution.

According to the present invention, as the operation amount of the image conversion network is reduced, conversion to a daytime image can be performed quickly, and accordingly, the present invention can be applied to a vision system that requires real-time image recognition or detection.

According to the present invention, two networks included in the image conversion network, i.e., a network that converts nighttime images into daytime images and a network that increases the size of daytime images, may be trained simultaneously.

Although the embodiments of the present invention have been described above, the present invention is not limited to the above embodiments, and may be practiced with various modifications within the scope of the detailed description and accompanying drawings of the present invention as long as it does not impair the effects without departing from the spirit of the present invention. It goes without saying that such embodiments fall within the scope of the present invention.

### DESCRIPTION OF SYMBOLS

1: Image processing system
100: Electronic device
110: Control unit
120: Communication unit
130: Storage unit
200: User terminal
210: Application
300, 300_1: Image conversion network
310: Pre-processing unit
320: Day/night conversion network
321: First generator
322: Discriminator
323: Second generator
3240: Encoder
3241, 3242: Layers of encoder
3250: Translation block
3251: Residual block
3252: Input value
3253: Next block
3260: Decoder
3261: Layer
3270: Down-sampling block
3271, 3272, 3273, 3274, 3275, 3276, 3277, 3278: Layer
3280: Probability block
3281: Sigmoid layer
330: Resolution conversion network
331: Generator
332: Discriminator
3330: Low-resolution block
3331: Layer
3340: Translation block
3341, 3342: SUM layer
3343: Layer
3350: High-resolution block
3351: Layer
3352, 3353: Block
340: Additional generator

What is claimed is:

1. An electronic device for image processing using an image conversion network, the device comprising:
a communication unit communicating with a user terminal to receive a nighttime image having an illuminance lower than a threshold level from the user terminal and a daytime image captured by a camera of the user terminal; and
a control unit for inputting the nighttime image into an image conversion network to generate a daytime image having an illuminance equal to or higher than the threshold level, wherein
the image conversion network includes:
a pre-processing unit for generating an input image by reducing a size of the nighttime image at a predetermined ratio;
a day/night conversion network for generating a first daytime image by converting an illuminance on the basis of the input image; and
a resolution conversion network for generating a final image by converting a resolution on the basis of the first daytime image.

2. The device according to claim 1, wherein the day/night conversion network includes:
a first generator for generating the first daytime image from the input image;
a second generator for generating a first nighttime image from the first daytime image; and
a discriminator for determining whether the first daytime image is a daytime image captured by the camera or an image generated by the first generator.

3. The device according to claim 2, wherein each of the first generator and the second generator includes:
an encoder for generating an input value by increasing the number of channels and reducing a size from the input image, and including at least one convolution layer for performing down-sampling;
a translation block including a plurality of residual blocks, in which each of the plurality of residual blocks is configured to add a result value, obtained by sequentially applying a convolution operation, instance normalization, a Rectified Linear Unit (ReLU) function operation, a convolution operation, and instance normalization to the input value, and the input value of the residual block in units of pixels; and
a decoder including at least one transpose convolution layer for converting a result received from the translation block so that a size and number of channels are the same as those of the input image, and performing up-sampling.

4. The device according to claim 2, wherein the discriminator includes:
at least one down-sampling block for dividing the input image into a plurality of patches; and
a probability block for outputting a probability value of each of the plurality of patches for being the captured image.

5. The device according to claim 2, wherein the first generator learns on the basis of a value of a first loss function indicating a result of determining whether the first daytime image is the captured image.

6. The device according to claim 2, wherein the second generator learns on the basis of a value of a second loss function indicating a difference between the first nighttime image and the input image.

7. The device according to claim 1, wherein the resolution conversion network includes:
a generator for generating a first high-resolution image having a resolution equal to or higher than a predetermined threshold level from the first daytime image; and
a discriminator for determining whether the first high-resolution image is the captured image or an image generated by the generator.

8. The device according to claim 1, wherein a value of a third loss function indicating a result of determining whether the first high-resolution image is a daytime image captured by the camera is derived.

9. The device according to claim 1, wherein the image conversion network further includes an additional generator for generating a second nighttime image on the basis of the first daytime image, wherein a value of a fourth loss function indicating a difference between the second nighttime image and the input image is derived.

10. A learning method of an image conversion network, the method comprising the steps of:
receiving a nighttime image having an illuminance lower than a threshold level from a user terminal and a daytime image captured by a camera of the user terminal, by a control unit;
inputting the nighttime image and the daytime image captured by the camera of the user terminal into the image conversion network, by a control unit;
generating an input image by reducing a size of the nighttime image at a predetermined ratio, by the image conversion network;
learning a method of generating a daytime image having an illuminance equal to or greater than the threshold level from a nighttime image having an illuminance lower than the threshold level on the basis of the input image and the daytime image captured by the camera, and generating a first daytime image, by a first network included in the image conversion network;
learning a method of generating a high-resolution image having a resolution equal to or greater than a threshold level from a low-resolution image having a resolution lower than the threshold level on the basis of the first daytime image and the daytime image captured by the camera, and generating a first high-resolution image, by a second network included in the image conversion network; and
learning on the basis of the first high-resolution image, by the first network and the second network.

11. The method according to claim 10, wherein the step of learning a method of generating a daytime image and generating a first daytime image includes the steps of:
generating the first daytime image on the basis of the input image, by a first generator;
determining whether the first daytime image is the daytime image captured by the camera, by a discriminator;
generating a first nighttime image on the basis of the first daytime image, by a second generator; and
learning on the basis of a value of a first loss function indicating a result of the determination by the discriminator and a value of a second loss function indicating a difference between the first nighttime image and the input image, by the first generator and the second generator.

12. The method according to claim 10, wherein the step of learning a method of generating a high-resolution image and generating a first high-resolution image includes the step of learning on the basis of a value of a third loss function indicating a result of determination by the discriminator, by the generator.

13. The method according to claim 10, wherein the step of learning on the basis of the first high-resolution image includes the steps of:
generating a third nighttime image on the basis of the first high-resolution image, by an additional generator; and
learning on the basis of a value of a fourth loss function indicating a difference between the third nighttime image and the input image, by a first generator among two generators included in the first network, a generator included in the second network, and the additional generator.
